(19) United States
(12) Patent Application Publication
(10) Pub. No.: US 2015/0260958 A1
(43) Pub. Date: Sep. 17, 2015

(54) SOLID-STATE IMAGING DEVICE

(71) Applicant: KABUSHIKI KAISHA TOSHIBA, Tokyo (JP)

(72) Inventor: Eiichirou KOSUGOU, Yokohama Kanagawa (JP)

(21) Appl. No.: 14/634,350

(22) Filed: Feb. 27, 2015

(30) Foreign Application Priority Data
Mar. 14, 2014 (JP) 2014-051711

(51) Int. Cl. G02B 13/00; H04N 5/225; H04N 5/369

(52) U.S. Cl. CPC G02B 13/0015; H04N 5/369; H04N 5/2254

(57) ABSTRACT

A solid-state imaging device is described. The solid-state imaging device includes an enclosure, a solid-state imaging element, and a transparent resin layer. The enclosure includes a bottom portion and a side wall portion provided on the bottom portion. The solid-state imaging element is disposed inside of the enclosure on the bottom portion. The transparent resin layer is in contact with the solid-state imaging element and fills the enclosure. The enclosure may be formed in a device packaging element.

### CROSS-REFERENCE TO RELATED APPLICATION

This application is based upon and claims the benefit of priority from Japanese Patent Application No. 2014-051711, filed Mar. 14, 2014, the entire contents of which are incorporated herein by reference.

### FIELD

Embodiments described herein relate generally to a solid-state imaging device.

### BACKGROUND

A solid-state imaging device in the related art is a device in which a solid-state imaging element having a plurality of micro lenses arranged on an upper surface thereof is disposed inside of a package which includes: an enclosure that is made of a planar bottom portion and a frame-shaped side wall portion provided on a surface of the bottom portion; and a transparent lid provided on the side wall portion of the enclosure. The solid-state imaging device is mounted on a mounting substrate for subsequent use. An outer electrode provided on a surface of the package is in electrical contact with a predetermined position on the mounting substrate to provide an electrical connection to the solid state imaging device.

In the solid-state imaging device in the related art, a difference in refractive index of the solid-state imaging element and the micro lens is large, so as to improve a light condensing amount. For this reason, an upper surface on which at least the plurality of micro lenses is formed comes into contact with a space (air layer) within the enclosure.

The upper surface of the solid-state imaging element comes into contact with the air layer as described above and also side surfaces of the solid-state imaging element also come into contact with the air layer. Only a lower surface of the solid-state imaging element comes into contact with the enclosure. Air is generally a poor conductor of heat (has low thermal conductivity). Therefore, heat generated from the solid-state imaging element is barely transferred to the air layer. Heat is transferred to the enclosure, the outer electrode, and the mounting substrate in mainly from a contact surface between the solid-state imaging element and the enclosure.

### DESCRIPTION OF THE DRAWINGS

FIG. 1 is a cross-sectional view illustrating a solid-state imaging device according to a first embodiment, which is mounted on a mounting substrate.

FIG. 2 is a cross-sectional view corresponding to a portion of FIG. 1, for illustrating a manufacturing method of the solid-state imaging device according to the first embodiment.

FIG. 3 is a cross-sectional view corresponding to a portion of FIG. 1, for illustrating the manufacturing method of the solid-state imaging device according to the first embodiment.

FIG. 4 is a cross-sectional view corresponding to a portion of FIG. 1, for illustrating the manufacturing method of the solid-state imaging device according to the first embodiment.

FIG. 5 is a cross-sectional view illustrating a solid-state imaging device according to another embodiment, which is mounted on the mounting substrate.

### DETAILED DESCRIPTION

An exemplary embodiment provides a solid-state imaging device having excellent heat dissipation characteristics.

In general, according to one embodiment, a solid-state imaging device is provided. The solid-state imaging element includes an enclosure, a solid-state imaging element, and a transparent resin layer. The enclosure includes a bottom portion and a side wall portion provided on the bottom portion. The solid-state imaging element is disposed on the bottom portion on the inside of the enclosure. The transparent resin layer is in contact with the solid-state imaging element, and fills the enclosure.

### First Embodiment

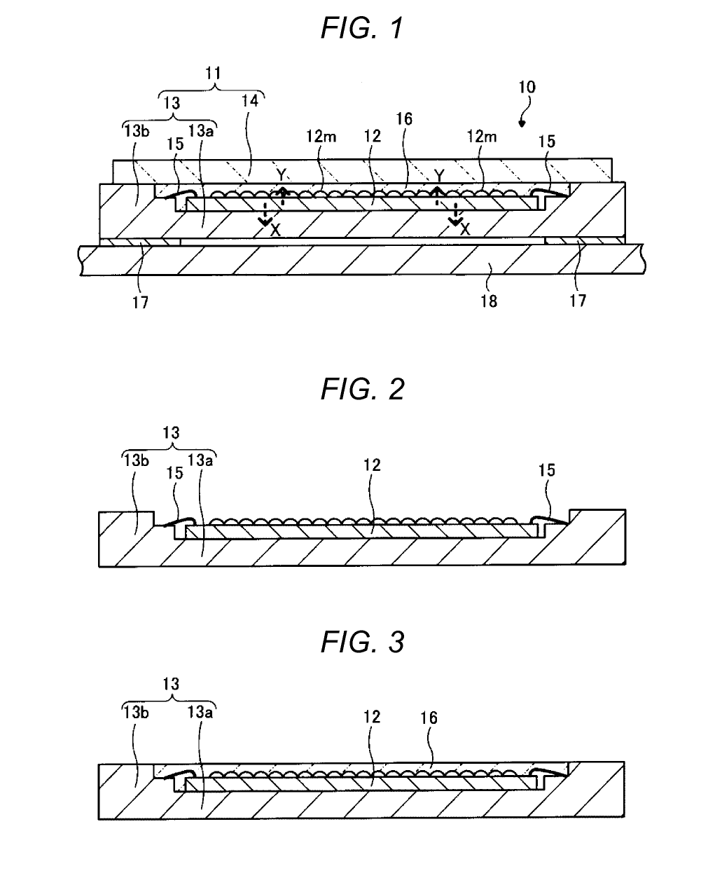

FIG. 1 is a cross-sectional view illustrating a solid-state imaging device according to a first embodiment. The solid-state imaging device 10 is mounted on a mounting substrate 18. A solid-state imaging device 10 illustrated in FIG. 1 is a device in which a solid-state imaging element 12, such as a CMOS sensor or a CCD sensor, is disposed on the inside of a package 11 so as to provide a quad flat no-lead (QFN) type image sensor, for example.

The package 11 for the image sensor includes an enclosure 13 and a transparent lid 14 which is provided on the enclosure 13.

The enclosure 13 is mainly made of an insulator material, such as a ceramic or a resin, and includes a board-shaped (planar) bottom portion 13a and frame-shaped (vertical) side wall portions 13b provided on a front surface of the bottom portion 13a.

In addition, the lid 14 is mainly made of a transparent insulator, such as glass, and is provided on the side wall portions 13b of the enclosure 13.

The package 11 for the image sensor forms a predetermined space which is surrounded by the bottom portion 13a and the side wall portions 13b of the enclosure 13, and the lid 14. In this predetermined space (cavity), the solid-state imaging element 12 is disposed on the front surface of the bottom portion 13a, and for example, is electrically connected to a pattern (not illustrated) on an inner side surface of one of the side wall portions 13b by a connection conductor, such as a wire 15. A plurality of micro lenses 12m are arranged inside the cavity on an upper surface of the solid state imaging element 12.

In addition, the pattern on the inner side surface of one of the side wall portions 13b is electrically connected to the pattern (not illustrated) on a rear surface of the bottom portion 13a of the enclosure 13 by a wiring (not illustrated) formed inside the enclosure 13. That is, electrical connections to the solid-state imaging element 12 are made via conductor elements extending through the enclosure 13 towards the mounting substrate 18.

In the solid-state imaging device 10, a transparent resin layer 16 is provided to come into contact with the solid-state imaging element 12 and fill the space in the package 11 left between transparent lid 14 and enclosure 13 after inclusion of the solid-state imaging element 12.

It is preferable that there be a difference between a refractive index of the transparent resin layer 16 and a refractive index of a micro lens 12m on the front surface of the solid-state imaging element 12. The refractive index of micro lens 12m may be, for example, 1.5. It is preferable in some embodiments that the difference in the refractive indexes of these materials to be equal to or greater than 0.3 when the refractive index of the micro lens 12m is greater than the refractive index of the transparent resin layer 16, and it is more preferable that the difference be equal to or greater than 0.5 in this situation. In the related art, the refractive index of the micro lens is typically about 1.5; the refractive index of the air is about 1.0. Thus, there is typically a difference of 0.5 between the refractive indexes of the micro lens and air. When the difference in the refractive indexes is to this extent, light is sufficiently condensed.

Furthermore, a thermal conductivity of the transparent resin layer 16 is greater than at least 0.024 (W/(m·K)), which is a thermal conductivity of the air, and the thermal conductivity of the transparent resin can be, for example, approximately 0.2 to 0.6 (W/(m·K)). Such a thermal conductivity of the resin may be obtained while still achieving a desired refractive index by using, for example, epoxy, silicone, acryl, or the like, as a main component of the resin, and having fine voids in the resin for lowering the refractive index, or by putting metal(s) into the resin to increase the refractive index.

In addition, the transparent resin layer 16 may be a single material, or may be a structure in which a plurality of materials is layered.

The above-described solid-state imaging device 10 can be mounted on a mounting substrate 18, via an outer electrode (not illustrated), using a mounting material such as a solder 17, provided on the rear surface) of the bottom portion 13a of the enclosure 13.

Next, a manufacturing method of the solid-state imaging device 10 according to the first embodiment will be described with reference to FIGS. 2 to 4. FIGS. 2 to 4 are respectively cross-sectional views corresponding to portions of FIG. 1, for illustrating the manufacturing method of the solid-state imaging device 10 according to the first embodiment.

First, as illustrated in FIG. 2, on the front surface of the bottom portion 13a of the enclosure 13, the solid-state imaging element 12 is disposed. The imaging element 12 and a predetermined position (for example, a wiring pattern on the inner side surface of one of the side wall portions 13b of the enclosure 13) of the enclosure 13 are electrically connected to each other by a connection conductor, such as the wire 15.

Next, as illustrated in FIG. 3, the transparent resin layer 16 is formed to come into contact with the solid-state imaging element 12 and to fill the space inside of the side wall portions 13b of the enclosure 13. For example, the transparent resin layer 16 is formed by potting.

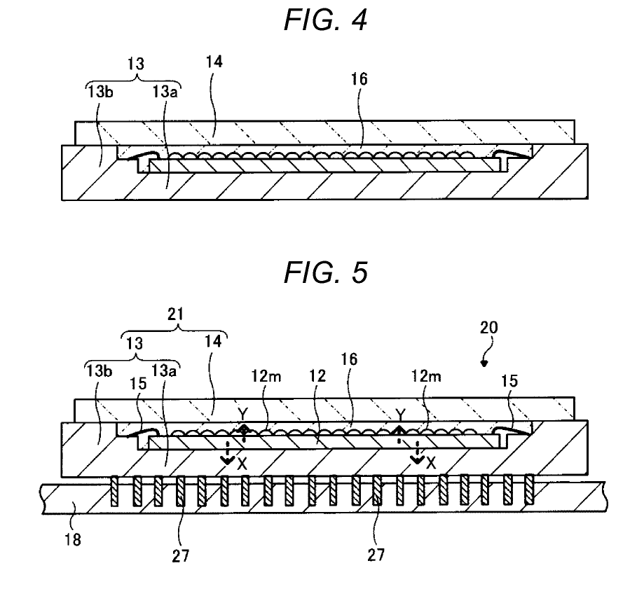

Next, as illustrated in FIG. 4, the lid 14 is fixed on the side wall portions 13b of the enclosure 13. In addition, in the process illustrated in FIG. 3, if it is possible to make the front surface of the transparent resin layer 16 protrude from the enclosure 13 plane, then the lid 14 may not necessarily have to be formed.

In this manner, the solid-state imaging device 10 illustrated in FIG. 1 is formed.

According to the above-described solid-state imaging device 10, in the space of the package 11, the transparent resin layer 16 comes into contact with the solid-state imaging element 12 and fills the space provided. Heat generated from the solid-state imaging element 12 is conducted to the enclosure 13 from the lower surface of the solid-state imaging element 12 as illustrated by an arrow X in the drawing At the same time, the resin layer 16 enables heat to be conducted from the solid state imaging element 12 to the package 11 via the resin layer 16 as illustrated by an arrow Y in the drawing. Therefore, it is possible to increase the amount of heat radiated from the solid-state imaging device 10.

### Second Embodiment

FIG. 5 is a cross-sectional view illustrating a solid-state imaging device 20 according to a second embodiment. The solid-state imaging device 20 is mounted on the mounting substrate 18. The solid-state imaging device 20 illustrated in FIG. 5 is a device in which the solid-state imaging element 12, such as the CMOS sensor or the CCD sensor, is disposed on the inside of a package 21 for a pin grid array (PGA) type image sensor.

Similar to the package 11 for the QFN type image sensor, the package 21 for the pin grid array (PGA) type image sensor includes: the enclosure 13 which is provided with the board-shaped (planar) bottom portion 13a and the frame-shaped (vertical) side wall portions 13b provided on the front surface of the bottom portion 13a; and the transparent lid 14 which is provided on the side wall portions 13b of the enclosure 13.

In the package 21, a predetermined space (cavity) is formed in the space enclosed by the bottom portion 13a and the side wall portions 13b of the enclosure 13, and the lid 14. In this predetermined space, the solid-state imaging element 12 is disposed on the front surface of the bottom portion 13a, and for example, is electrically connected to a wiring pattern on the inner side surface of a side wall portion 13b by a connection conductor, such as wire 15.

In the space of the package 21 in which the solid-state imaging element 12 is disposed, the transparent resin layer 16 is provided to come into contact with the solid-state imaging element 12 and to fill the remaining space.

The above-described solid-state imaging device 20 is used by being mounted on the mounting substrate 18, via a plurality of outer electrodes which are made of a plurality of pins 27 provided on the rear surface of the bottom portion 13a of the enclosure 13.

Since a manufacturing method of the solid-state imaging device 20 according to the second embodiment is similar to the manufacturing method of the solid-state imaging device 10 according to the first embodiment, the description thereof will be omitted.

In the above-described solid-state imaging device 20, in the space of the package 21, the transparent resin layer 16 is provided to come into contact with the solid-state imaging element 12 and to fill the space. Heat generated from the solid-state imaging element 12 is conducted to the enclosure 13 from the lower surface of the solid-state imaging element 12 as illustrated by an arrow X in the drawing. At the same time, heat the resin layer 16, which contacts the solid state imaging element 12, enables additional heat to be conducted from the solid state imaging element 12 to the package 21 as illustrated by an arrow Y in the drawing. Therefore, it is possible to improve the heat radiation from the solid-state imaging device 20.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device, comprising:
an enclosure having a bottom portion and a side wall portion on the bottom portion;
a solid-state imaging element disposed within the enclosure on the bottom portion; and
a transparent resin layer in contact with the solid-state imaging element and filling the enclosure.

2. The solid-state imaging device according to claim 1, wherein the transparent resin layer has a thermal conductivity greater than a thermal conductivity of air.

3. The solid-state imaging device according to claim 1, wherein the transparent resin layer is a single material.

4. The solid-state imaging device according to claim 1, wherein the transparent resin layer is a plurality of materials stacked in layers.

5. The solid-state imaging device according to claim 1, further comprising:
a transparent lid covering the solid-state imaging element and provided on the side wall portion of the enclosure,
wherein the transparent resin layer is in contact with the transparent lid, and a space formed by the enclosure and the transparent lid is filled with the transparent resin layer.

6. The solid-state imaging device according to claim 1, further comprising:
a plurality of electrically conductive pins extending through the bottom portion of the enclosure.

7. The solid-state imaging device according to claim 1, wherein a conductive portion in the bottom portion of the enclosure electrically connects the solid-state imaging element to an electrode disposed on an outer surface of the bottom portion of the enclosure.

8. The solid-state imaging device according to claim 1, wherein the transparent resin layer includes a plurality of cavities formed therein.

9. The solid-state imaging device according to claim 1, wherein the transparent resin layer includes a metal disposed therein.

10. The solid-state imaging device according to claim 1, further comprising:
a plurality of micro lenses disposed on the solid-state imaging element.

11. The solid-state imaging device according to claim 10, wherein a refractive index of the micro lenses is greater than a refractive index of the transparent resin layer by at least 0.3.

12. A solid-state imaging device, comprising:
a first packaging element including an enclosure having a planar bottom portion and a sidewall extending from the planar bottom portion in a first direction;
a solid-state imaging element including an upper surface, a bottom surface, and side surfaces disposed within the enclosure with the bottom surface adjacent the planar bottom portion and the upper surface at a height above the planar bottom portion that is less than a height of the sidewall above the planar bottom portion;
a plurality of micro lenses disposed on the upper surface of the solid-state imaging element, the plurality of micro lenses having an outer surface facing away from the upper surface of the solid-state imaging element; and
a transparent resin layer in contact with the outer surface of the plurality micro lenses and filling the enclosure.

13. The solid-state imaging device according to claim 12, further comprising:
a transparent lid covering the solid-state imaging element and contacting the side wall portion of the first packaging element.

14. The solid-state imaging device according to claim 13, wherein the transparent resin layer is in contact with the transparent lid.

15. The solid-state imaging device according to claim 12, wherein the first packaging element is part of a quad-flat no leads device package.

16. The solid-state imaging device according to claim 12, wherein the first packaging element is part of a pin grid array device package.

17. The device according to claim 12, wherein a refractive index of the plurality of the micro lenses is greater than a refractive index of the transparent resin layer by at least 0.3.

18. A method of forming a solid-state imaging device comprising:
positioning a solid-state imaging element on a bottom surface portion of an enclosure formed in a first packaging element, wherein the enclosure includes a sidewall portion extending from the bottom surface portion; and
filling the enclosure in the first packaging element with the solid-state imaging element positioned therein with a transparent resin layer.

19. The method of claim 18, further comprising:
placing a transparent lid over the transparent resin layer that is within the enclosure.

20. The method of claim 18, further comprising:
mounting the first packaging element on a mounting substrate.
